(19) United States
(12) Patent Application Publication
(10) Pub. No.: US 2013/0024368 A1
(43) Pub. Date: Jan. 24, 2013

(54) TRANSACTION PROCESSING SYSTEM

(71) Applicant: Toby SCAMMELL, San Francisco, CA (US)

(72) Inventor: Toby SCAMMELL, San Francisco, CA (US)

(73) Assignee: Oto Analytics, Inc., San Francisco, CA (US)

(21) Appl. No.: 13/552,410

(22) Filed: Jul. 18, 2012

Related U.S. Application Data
(60) Provisional application No. 61/509,319, filed on Jul. 19, 2011.

(51) Int. Cl. G06Q 20/34; G06Q 20/40; G06Q 20/14

(52) U.S. Cl. 705/40; 705/41

(57) ABSTRACT

Customers may give different merchants card information for purchasing products or services. The merchants may send the card information to a payment gateway or bank that confirms the card information and the amounts associated with the purchases. At least some of the same card information may be sent to a data provider. The data provider may generate transaction data that combines the card information with card information for other purchases from other merchants. Other performance metrics may be generated by comparing the transaction data with other information related to the customers, merchants, or products. Transaction processing and tracking is simplified since some of the same card information used for purchasing products or services can also be used for generating the transaction data.

The present application claims priority to U.S. Provisional Patent Application, Ser. No. 61/509,319, entitled: OTO CHECKOUT PROCESS, filed Jul. 19, 2011, which is herein incorporated by reference in its entirety.

### BACKGROUND

Known e-commerce sites may collect user billing information, such as a credit card number, a type of credit card, a home address, etc. The billing information may be forwarded to a payment gateway or bank. The payment gateway or bank may route the data through their systems and/or partner systems to determine if the billing information is valid and whether the user can be charged a transaction amount (authorization). Assuming the billing information is authorized, the transaction may proceed toward settlement where the user is charged and the merchant receives money from the user.

Known e-commerce sites may also want to track user purchasing behaviors. For example, the e-commerce site may be interested in tracking the different types of products being purchased by the users. Typically, the users must separately enter personal information into the website. Known web-based tracking applications may then use the personal information to monitor user accesses to different websites and track the types of products viewed and/or purchased by the different website users.

### BRIEF DESCRIPTION OF THE DRAWINGS

FIG. 1 depicts an example of a computing system for receiving card information and transaction data.

FIG. 2 depicts an example of a system for processing and tracking transactions.

FIG. 3 depicts another example of a system for processing and tracking transactions.

FIG. 4 depicts yet another example of a system for processing and tracking transactions.

FIG. 5 depicts an example of different types of merchants that may use the system for processing and tracking transactions.

FIG. 6 depicts an example of different types of data inputs that may be used for tracking transactions.

FIG. 7 depicts an example process for extracting different types of data inputs and correlating the data inputs with transaction data.

FIG. 8 depicts an example process for forecasting merchant performance metrics.

FIG. 9 depicts an example of a computing system for processing and/or tracking transactions.

### DETAILED DESCRIPTION

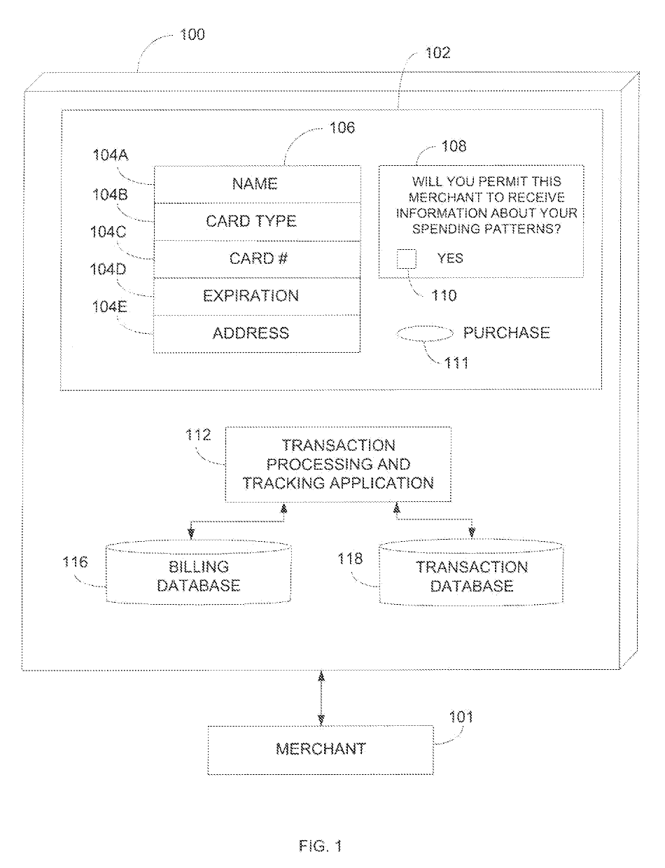

FIG. 1 depicts an example of a computing system 100 operating an application 112 for processing and tracking transactions. Computing system 100 may be operated by a merchant, an on-line business, an in-store business, a company, an individual, an enterprise, a website, or the like, or any combination thereof, or any other entity that performs transactions. Computing system 100 may comprise a personal computer, laptop computer, mobile device, smart phone, tablet computer, network server, card reader, electronic scanning device, or the like, or any combination thereof.

Computing system 100 may also comprise memory storage for retaining a billing database 116 and/or a transaction database 118. Any combination of disc storage, random access memory (RAM), flash memory, or the like or any combination thereof may be used for storing the data contained in billing database 116 and/or transaction database 118.

Billing database 116 and transaction database 118 may be contained in the same computing system 100 operating transaction processing and tracking application 112 or may be located in a different computing system, such as in a network data server connected to computing system 100. In another example, billing database 116 may be located in a different computing system than transaction database 118. All of the different computing systems may be coupled together via one or more buses or networks. For example, the computing systems may be connected via local area networks (LANs), wide area networks (WANs), fiber channel networks, or the like, or any combination thereof.

Computing system 100 may include a screen 102 for displaying an electronic checkout form 106. Checkout form 106 may be configured to capture card information 104 associated with a credit card, debit card, bank card, money card, electronic bank account, and/or any other device or information used for purchasing goods or services or performing a transaction. Checkout form 106 may be similar to the forms used on existing ecommerce websites for collecting debit card, credit card, or other bank card information. Card information 104 does not necessarily need to be information contained on a credit card or debit card and may comprise any information, such as personal information, financial information, bank account information, credit information, etc. used for conducting transactions.

Checkout form 106 may comprise multiple different fields for capturing different types of card information 104A-104E. For example, card information 104 may comprise a user first name and a user last name 104A, a credit card type 104B, a credit card number 104C, a credit card expiration date 104D, and a user address 104E. The user address 104E may comprise a home or business address, a zip code, a state, and/or a phone number. Other card information 104 may include a card security code (CSC, CVV2, etc.) or any other information associated with the user or a financial account.

A user, sales personnel, etc. may enter card information 104 into checkout form 106 via an input device, such as a keyboard, touch screen, mouse, credit card reader, scanner, or the like or any combination thereof. The user may be any person, buyer, customer, business, enterprise, entity, or the like, or any combination thereof that wishes to conduct a transaction with a merchant, an entity, an enterprise, etc. that operates or uses computing system 100 for conducting transactions. For explanation purposes, the entity operating or using computing system 100 for performing transactions with users will be referred to generally as a merchant 101.

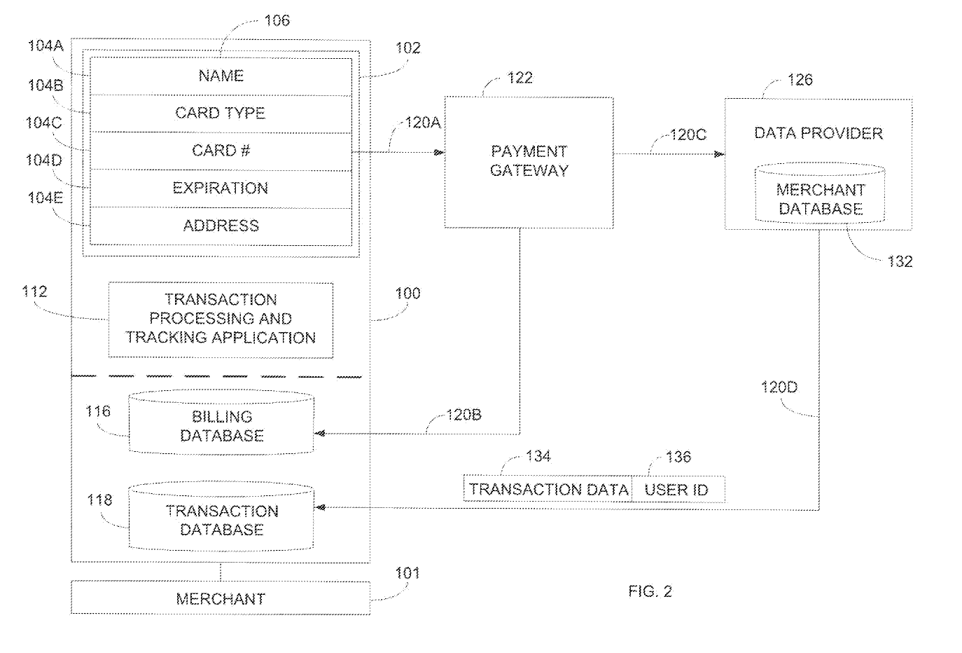

The transaction processing and tracking application 112 may use card information 104 for initiating and/or completing a transaction with the user. For example, application 112 may send card information 104 to a payment gateway or bank for payment authorization (see FIG. 2). Upon successful completion of the payment authorization, the transaction may be completed. Merchant 101 may then ship, perform; and/or authorize products or services to the user in response to receiving an authorization back from the gateway or bank. Some or all of card information 104 may be stored in billing database 116.

The user may authorize registration of card information 104 into a tracking program that uses card information 104 to track user purchases at different merchants and authorizes merchant 101 to receive transaction data regarding those purchases. Card information 104 may be registered and stored in billing database 116 and the transaction data associated with the user purchases at the different merchants may be stored in transaction database 118.

### User Consent for Transaction Tracking

Computing system 100 may query the user for explicit consent to use card information 104 for tracking associated transactions. For example, computing system 100 may display an authorization form 108 that requires the user to check a box 110 before card information 104 can be registered in the transaction tracking program that tracks the user transactions with different merchants. In one example, authorization form 108 may ask “Will you permit this merchant to receive information about your spending patterns?” The user may agree by selecting box 110. Authorization form 108 may list any other terms and conditions associated with registering card information 104 with the transaction tracking program.

Computing system 100 may record the user consent from authorization form 108 and the associated card information 104 from checkout form 106 in billing database 116 in response to the user selecting box 110. If the user does not select box 110, application 112 may record the user rejection and may not register card information 104 in the transaction tracking program.

The user may consent to the transaction tracking in a variety of different ways. For example, authorization form 108 may not be displayed with checkout form 106 and consent may be attained implicitly when the user makes a purchase and agrees to terms and conditions of that purchase. For example, the user may both complete the purchase and at the same time agree to the terms and conditions associated with the transaction tracking program. Otherwise, the user can choose to not complete the purchase. If the user completes the purchase, card information 104 may be registered in billing database 116 and distributed to the payment gateway and/or data provider for additional transaction processing and tracking. Other schemes for providing user consent may also be used.

### Incentives

The user may receive an incentive or something of value in return for agreeing to register card information 104 in the transaction tracking program. The incentive may take the form of an instant discount applied to a product or service sold by merchant 101. The discount or reward points may be associated with the product or service the user is currently purchasing or may be associated with future purchases. Other incentives may provide the user with rewards points or a rebate at a later date for participation in the transaction tracking program.

Card information 104 entered into checkout form 106 may be validated for accuracy similar to a standard e-commerce checkout form. In certain cases validation may also be performed on a field-by-field basis, where card information 104A-104E for each field of checkout form 106 may be validated once the user has filled in the field and moved on to the next field.

This validation may be performed before the user clicks, on a purchase icon 111 and submits card information 104 to the gateway or bank for subsequent transaction validation. For example, a zip code in address information 104E may be validated to ensure it consists of five numbers. In another example, credit card number 104C may be checked against known card type patterns to confirm a match with the selected card type 104B. Other anti-fraud checks can also be run on the submitted card information 1.04.

Card information 104 may be collected in different ways, such as via phone where the user directs a customer service representative to manually enter card information 104 into computing system 100. In another example, card information 104 may be collected by swiping a credit card or debit card through a card reader or card terminal during a card present transaction at a merchant store location. The card reader or card terminal may be coupled to computing system 100 through any type of bus-or network connection.

Card information 104 may be encoded based on the consent or lack of consent to participate in the transaction tracking program. An indication of user authorization and participation in the transaction tracking program and encoding of associated card information may take different forms including assigning a unique customer number to the user that is within a range of customer numbers known to have provided consent for the transaction tracking program.

The authorization indicator may also take the form of an additional field that is added to card information 104 indicating the user has consented to participate in the transaction tracking program. For example, a “1” entered into an authorization field of card information 104 may indicate the user has consented to transaction tracking. A “0” entered into the authorization field of card information 104 may indicate the user has declined to participate in the transaction tracking program.

As mentioned above, transaction processing and tracking application 112 may be configured to automatically register all users in the transaction tracking program who submit valid data in checkout form 106. Thus, additional authorization operations and coding may not be necessary when card information 104 is entered and submitted to the payment gateway.

### Authorization and Billing

FIG. 2 depicts a payment gateway 122 coupled between computing system 100 and a data provider 126. Data provider 126 is coupled between payment gateway 122 and computing system 100. Connections between computing system 100, payment gateway 122, and data provider 126 may comprise buses, landline networks, wireless networks, telephone networks, public services telephone networks (PSTN), Internet networks, local area networks (LANs), wide area networks (WANs), fiber channel networks, or the like, or any combination thereof.

In one example, payment gateway 122 may be a bank or processor that acts as a front-end connection to financial institutions servicing different credit card and debit card brands. Payment gateway 122 may receive inputs from a variety of different applications and route those inputs to the appropriate bank, financial institution, processor, or the like or any combination thereof. Payment gateway 122 may communicate with the financial institution or processor using dial-up connections, web-based connections, privately held leased lines, or the like, or any combination thereof.

In one example, payment gateway 122 and/or data provider 126 may be PCI compliant. PCI refers to a payment card industry data security standard (PCI DSS) comprising a set of requirements designed to ensure that companies that process, store or transmit credit card information maintain a secure environment. Payment gateways and PCI compliant payment gateways are known to those skilled in the art and are therefore not described in further detail.

Payment gateway 122 may authorize and bill for the purchase associated with card information 104, regardless of user consent to participate in the transaction tracking program. For example, computing system 100 may submit card information 104 to payment gateway 122 in order to buy a table that costs $99. Payment gateway 122 may provide authorization to charge $99 to the credit card or bank account associated with card information 104. This process may be similar with current checkout forths on e-commerce websites, where the website collects user billing information, such as credit card number, type, etc., and forwards the billing information to a payment gateway or a bank for authorization and billing.

Payment gateway 122 or the bank may route card information 104 through internal systems and partner systems to determine if card information 104 is valid and the account associated with card information 104 can be charged the transaction amount (authorization). Assuming card information 104 is authorized, the transaction may proceed toward settlement where the associated user account is charged and merchant 101 associated with computing system 100 receives money for the transaction in a merchant account identified in billing database 116. Card information 104-may be authorized by payment gateway 122, for example by confirming the purchase amount is available in a bank account of the user. Payment gateway 122 may send an authorization back to merchant 101 to complete the transaction for purchasing the product or service.

### Transaction Tracking Program

In addition to the handoff to payment gateway 122 or bank, an additional communications channel may be created where at least some of card information 104 may be passed to data provider 126. Data provider 126 may be any data processor, data provider, enterprise, server, computing system, etc. with the technical ability and legal right to view credit card transactions, debit card transactions, product purchases, user information, or any other bank or financial transaction associated with card information 104.

Data provider 126 may be operated by a third party separate from merchant 101 operating computing system 100 and separate from the entity, enterprise, bank, etc., operating payment gateway 122. In other examples, a same entity, enterprise, bank, etc. may operate any combination of computing system 100 operated or used by merchant 101, payment gateway 122, and/or data provider 126. Data provider 126 may be a server or any other type of computing system that tracks any of the transactions conducted by one or more payment gateways 122.

Data provider 126 may receive card information 104 and consent information indicating the user has approved use of card information 104 in the transaction tracking program. The card information 104 may include a type of product or service being purchased, a dollar amount of the purchase, a date and location of the purchase, and/or an identification of merchant 101 involved in the transaction. Data provider 126 may receive on-line and in-store card information and other transaction information from other merchants and may obtain additional data from other sources related to the users, the merchants, or the products sold by the merchants. Data provider 126 may accumulate the transaction information from the different merchants into transaction data 134.

Data provider 126 may correlate different information in the transaction data 134. For example, data provider 126 may identify users or merchants in transaction data 134 that have purchased or sold particular type of products or purchased or sold products in a same location. Data provider 126 may also periodically receive card information 104 for new card numbers registered in the transaction tracking program and send transaction data 134 associated with the new card numbers to the other merchants.

Data provider 126 may accumulate and store transaction data 134 in database 132 and send at least some of transaction data 134 back to merchant 101. Transactional data 134 may also be sent to other merchants previously authorized either explicitly or implicitly by the user to receive transaction data 134.

In operation 120A, card information 104 is securely passed by application 112 to payment gateway 122. Payment gateway 122 may authorize and settle payment from a customer bank card associated with card information 104. In operation 120B, payment gateway 122 may send information back to merchant 101 confirming the purchase and confirming the account associated with card information 104 can, or has been, billed for the purchase amount.

In operation 120C, payment gateway 122 may securely send card information 104 and any other associated transaction information to data provider 126 along with a unique code that identifies the user associated with card information 104. In operation 120D, data provider 126 may provide qualified transaction data 134 associated with the user to merchant 101. For example, transaction data 134 may comprise on-line and in-store purchase information from different merchants where the user has made purchases. Transaction data 134 may be associated with the user via a unique user identifier (User ID) 136.

Merchant 101 may use user ID 136 to associate transaction data 134 with particular customer billing information or customer transaction data in billing database 116 or in transaction database 116, respectively. Customer ID 136 may be used wherever possible to associate customer payments and transactions with associated user accounts without using actual card numbers.

Transaction data 134 may include any information associated with the user transaction, such as:
time and date card was used;
merchant name where card was used;
address of merchant;
merchant store number;
amount of purchase;
unique ID 136 that refers to the card or user in question;
other transaction related numbers and codes;
purchased product information; and/or
details of purchase, including level 2 or level 3 data.

Examples of level 2 and level 3 data include credit card number, expiration date, billing address, zip code, invoice number, customer c ode, sales tax information, freight amount, duty amount, product/service identifier (item ID), product/service description, quantity, item amount (e.g., $100), and unit of measure. Unit of measure might comprise a number of items purchased, an amount of an item purchased, or the like, or any combination thereof.

Merchant 101 may use transaction data 134 for various purposes including offering rewards, targeting advertising, targeting products and services for purchase or discount, other business intelligence applications, or the like, or any combination thereof. For example, transaction processing and tracking application 112 may identify all customers in transaction database 118 that have purchased a particular type of product either from merchant 101 or from other merchants. Merchant 101 may program application 112 to send an email message, a text message, a social network message, a website message, or any other type of message to each of the identified customers advertising similar products.

Application 112 may also be configured to obtain other data associated with the user or merchants for comparing with transaction data 134: Application may then conduct different analytics and forecast different merchant performance metrics based on the comparisons. This analysis is described in more detail below. Alternatively, the metrics may be generated by the data provider 126.

Thus, the system in FIG. 2 provides a single checkout form 106 that only requires the user to enter card information 104 once to both enable secure billing while at the same time registering card information 104 into a transaction tracking program that tracks user spending behaviors with different merchants. The single entry of card information 104 may be less complex than existing systems that require users to enter credit card information once for billing purposes and then enter other personal information a second time for other merchant transaction tracking operations.

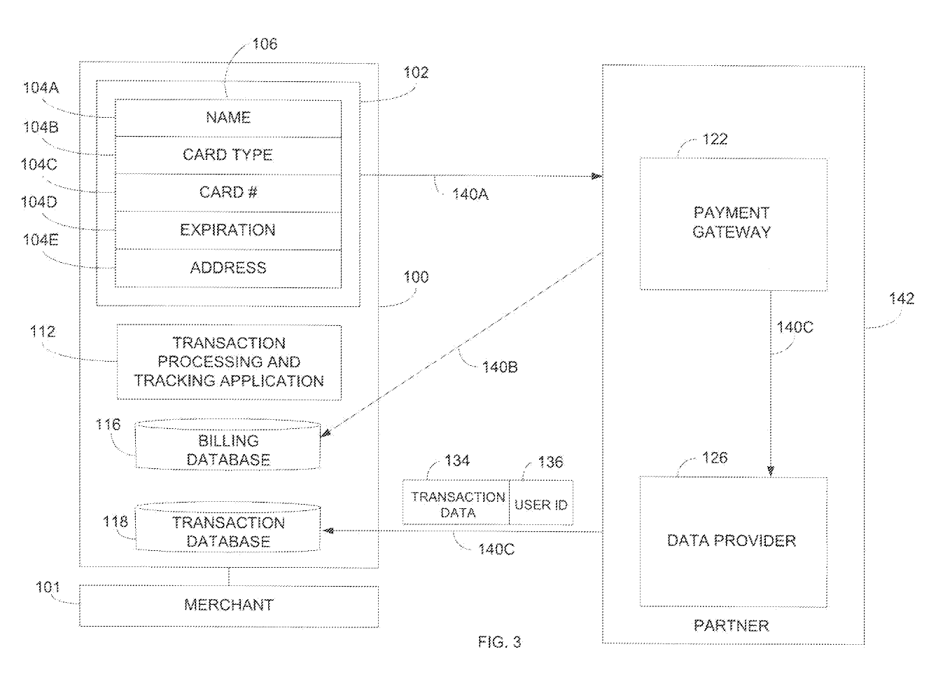

FIG. 3 shows a pass then split scheme for processing and tracking user transactions. In operation 140A, merchant 101 operating computing system 100 may securely send card information 104 to a PCI compliant partner 142. Partner 142 may comprise servers, computing devices, storage systems, etc. for operating a payment gateway or merchant bank 122. Payment gateway 122 may process card information 104 and in operation 140B may send information back to computing system 100 confirming the purchase and confirming the account associated with card information 104 can be, or has been, billed for the transaction amount.

Partner 142 may also operate as data provider 126 generating, storing, and sending transaction data 134. In operation 140C, data provider 126 may generate transaction data 134 from card information 104 and any other associated information received from different merchants. Partner 142 may send transaction data 134 and an associated user ID 136 to transaction database 118 of merchant 101 and to any other authorized merchants.

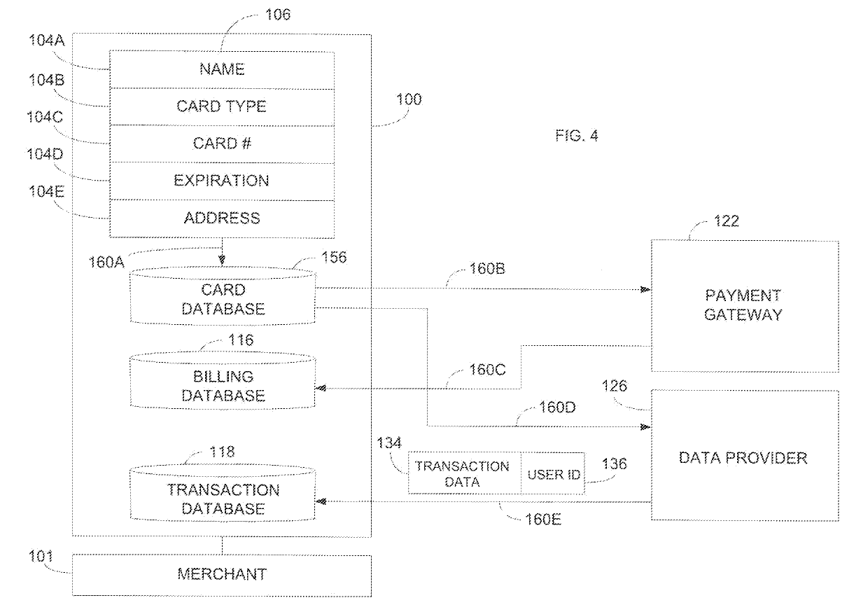

FIG. 4 depicts an example of a store then split scheme for processing and tracking transactions. In operation 160A, merchant 1.01 captures and stores billing information 104 in a PCI compliant fashion in card database 156. In operation 160B, merchant 101 may securely send card information 104 to payment gateway 122. In operation 160C, payment gateway 122 may send information back to merchant 101 confirming the user purchase and confirming the user card can or was billed for the transaction amount.

In operation 160D, computing system 100 may securely and separately send card information 104 to data provider 126. In operation 160E, data provider 126 may generate and send qualified transaction data 134 back to computing system 100 for merchant 101 associated and to any other qualified merchants. Again, transaction data 134 may include card information 104 and any other associated purchase information received from merchant 101 and any other authorized merchants.

### On-Line Example

Assume a company X operates a website X.com for selling gift cards to local restaurants. Company X may operate or use on-line servers and databases referred to as computing system 100 in any one of FIG. 1, 2, 3 or 4 that support website X.com. A user visits X.com looking to buy a gift card for restaurant Y. The user finds the gift card and adds the gift card to an on-line shopping cart. The user enters card information 104 into checkout form 106, agrees to the terms and conditions, and clicks the purchase icon to complete the purchase.

When the card transaction for the user settles at payment gateway 122, company X receives money in an associated bank account. Company X may also automatically receive transaction data 134 from data provider 126 identifying other merchants where the user has spent money. For example, transaction data 134 may identify other restaurants where the user has purchased meals. The next time the user visits X.com, company X may use the spending information contained in transaction data 134 to personalize the user experience, give the user better offers, and/or suggest new products or services.

### Phone Example

A shirt company may sell clothes over the phone. The user may call the phone number for the shirt company and tell a sales agent what product the user would like to purchase. The user may provide card information 104 to a sales agent to complete the to purchase. The user may verbally agree to the terms and conditions of the purchase, which may include registering card information 104 into the transaction tracking program.

The sales agent may enter card information 104 into checkout form 106 displayed by computing system 100. The user may verbally confirm the purchase and the sales agent may submit card information 104 to payment gateway 122 on behalf of the user. The computer and/or servers for the shirt company may operate as computing system 100 shown in any of FIG. 1, 2, 3, or 4.

The user may receive shirts as normally provided by the shirt company. Card information 104 may be used to charge the bank account or payment account for the user and also register card information 104 for the user into the transaction tracking program. The shirt company may receive money from the user in an associated bank account. The shirt company may also start automatically receiving transaction data 134 associated with purchases at other merchants.

### In-Store Example

A user may visit a store X to purchase a dress. Store X may operate the computers, servers, and databases in computing system 100 described in any one of FIG. 1, 2, 3, or 4. At the time of checkout the user may be asked to agree to the terms and conditions of the purchase that may include authorization to register card information 104 in the transaction tracking program. When the user card is swiped, card information 104 may be used to bill the bank account of the user and simultaneously register the user in the transaction tracking program.

The user may be charged for the purchase and store X may receive money from the bank account of the user. Store X may also begin receiving transaction data 134 identifying other stores where the user has made purchases. Transaction data 134 may indicate the user spends money at a number of boutiques and also visits stores that are close to the location of store X. Store X may use transaction data 134 to improve the user shopping experience and provide the user with better service upon future visits. For example, store X may provide the user with a gift card to a coffee shop is identified in transaction data 134 as often frequented by the user and located next to store X.

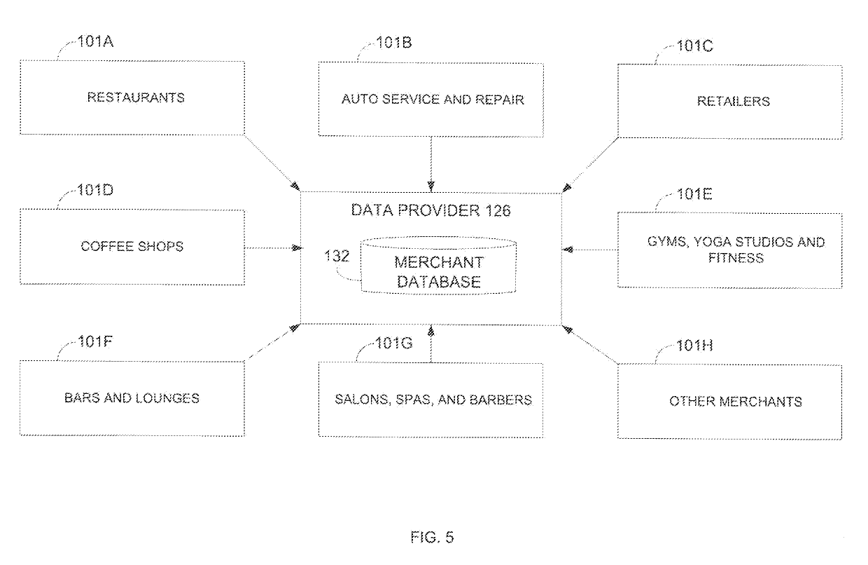

FIG. 5 shows examples of different types of merchants 101 that may send card information, other related purchase information, or any other transaction information to data provider 126. For example, restaurants 101A may send information associated with meal purchases. Auto service and repair businesses 101B may send information associated with car sales and services, and retail businesses 101C may send information associated with purchases for different retail products or services. Coffee shop businesses 101 D may send information for coffee and food purchases. Gym, yoga and other fitness related businesses 101E may send information for purchases of fitness services and products. Bar and lounge businesses 101F may send information for food and beverage purchases. Salon, spa, and barber businesses 101G may send information for purchases of beauty products and services. Any other merchant businesses 101 H may send any type card information or related purchase information to data provider 126 for storing in merchant database 132 and use in the transaction tracking program.

### Analytics

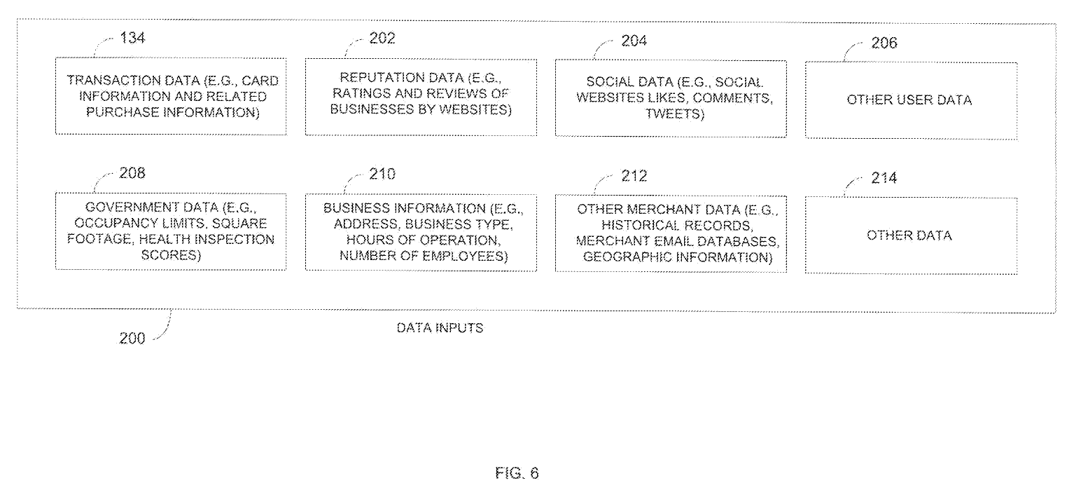

FIG. 6 depicts how transaction data 134 from different merchants 101 may be combined with other data inputs 200 from other data sources to create a rich customer experience and to better understand the user in the context of a merchant business. FIG. 6 identifies some of the other types of data sources and their associated data 200 that may be captured by the computing systems of merchants and/or by data provider 126 and synthesized with transaction data 134.

Data inputs 200 may include reputation data 202 such as on-line reviews and ratings aimed at the merchant businesses in FIG. 5. For example, websites such as Yelp® may provide numerical or star ratings for different businesses and provide overall reviews and specific member reviews for the different businesses. The reviews and ratings may be combined and/or correlated with transaction data 134 for performing analytics and providing addition transaction metrics.

Social data 204 may comprise “likes”, comments, tweets, etc. provided by the users, the friends of users, or other members of social networking sites. For example, users on a social website such as Facebook® or Twitter® may post comments, “likes”, texts, comments, etc. for particular merchants or products. This social data 204 may be compared with transaction data 134 to provide additional analytics for the products, merchants, and/or users. Other social data 204 may include engagement data indicating how often the user engages with various online sites, webpages, or features.

User data 206 may comprise aggregated user spending data, such as identification of businesses where users spend money and the frequency and magnitude of that spending. Other user data 206 may comprise demographic data, such as the age, sex, and interests of the users. User data 206 may be extracted from user profiles on social websites, merchant survey information, transaction data 134, and/or any other source of user purchases or demographics.

Merchant data may also be added to transaction data 134 and/or compared with transaction data 134 for providing additional analytics. Government data 208 may comprise occupancy limits for facilities operated by the merchants, square footage of the buildings operated by the merchants, public health inspection records and scores for the facilities operated by the merchants, merchant licenses; and/or zoning requirements for locations where the merchants operate businesses.

Business information 210 may comprise a merchant address, a merchant business type, merchant hours of operation, and merchant employee data, such as number of employees, and types of employees, etc. Other merchant data 212 may comprise merchant historical records such as sales histories, products or services previously sold by the merchants, financial records, and geographic information. Merchant data 212 may also include merchant email databases and merchant social data, such as merchant-related activity on social websites.

Other data 214 may be accumulated with transaction data 134 and/or used for performing analytics on transaction data 134. Other data 214 may not be specific to either the merchants or users associated with transaction data 134. For example, other data 214 may include geographic information for different parts of the country, crime statistics in the geographic regions, transportation data for different geographic regions, and/or meteorological data such as forecasted and actual weather for different times of the year for different geographic regions.

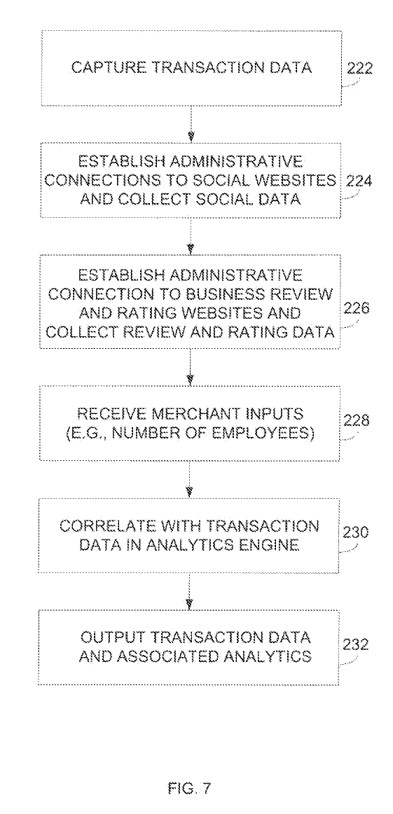

FIG. 7 depicts one example of how data is collected from merchants and other data sources shown in FIG. 6. In operation 222, the connections and authorization are established for capturing card information and any other purchase information and generating associated transaction data. In operation 224, connections may be established with social websites, or any other data sources, and social data associated with the merchant, users, and/or transactions are collected. For example, an administrative connection is established with a social website for a user and the user profile and/or web pages are searched for any ratings or comments associated with a particular merchant or product or any personal information associated with the user or merchant.

Operation 226 may establish administrative connections with other on-line sites or data sources such as a review and rating website. The reviews and ratings for the merchant, or products or services sold by the merchant, are collected through an Application Programming Interface (API) and stored in the computing system operated by the merchant or data provider. In operation 228, other inputs may be received directly from the merchants or extracted from the websites operated by the merchants. For example, merchants may enter information associated with the number of employees, store locations, square footage of the stores, hours or operation, inventory, etc.

In operation 230, the extracted data is correlated with the transaction data. For example, the number of sales for a particular merchant may be identified in the transaction data. The social data may be correlated with the sales data to provide a graph showing the relationship between ratings of the merchant by the users and the number of sales by the same merchant. In operation 232, the transaction data and associated analytics may be output. For example, graphs or spread sheets may be output with the transaction data showing comparisons of sales associated with the transaction data with sales for other merchants in a same geographic location.

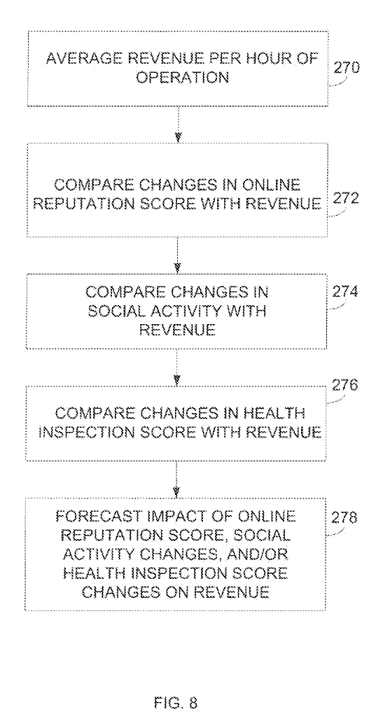

FIG. 8 depicts one example of how analytics may be generated and used to help merchants better understand how their businesses are performing over time, how the business compares with competitors, what factors have an impact on the business performance, and how the business can improve performance. In operation 270, transaction data may be used to determine an average revenue per hour of operation for a merchant. For example, all of the sales amounts associated with card transactions in the transaction data may be totaled for each hour.

In operation 272, any changes in an online reputation score for the merchant may be compared with the average revenue per hour. For example, an overall rating of a restaurant on an online review website may change from four stars to three stars. Subsequent changes in the average revenue for the merchant may be compared with the rating change.

In operation 274, other changes in social on-line activity may be compared with revenue. For example, a current number of likes or dislikes asserted by users for the restaurant may be compared in time with the rating provided by the online review website. In another example, the number of hits on the merchant website may be compared with the merchant rating and/or with the revenue information. In operation 276, changes in a health inspection score for the restaurant may be compared with subsequent average revenue for the restaurant and/or any of the other metrics associated with the merchant or the products or services sold by the merchant.

The comparisons may be used in operation 278 to forecast the impact of the changes with merchant revenue, transaction volume, and average transaction size. For example, the historical comparison of user inputs and an overall merchant ratings may indicate that the restaurant will lose half a star rating unless a new review is received in the next ten days. The predicted changes in the merchant on-line rating may also be used to predict future revenue for the restaurant. For example, past historical data may indicate that a loss of a half star rating may result in up to a 20% loss in revenue. The computer system may also predict the impact of the predicted lower review rating based on the time of year, the geographic location of the merchant, or any other factors.

The comparisons may be used in operation 278 to forecast the impact of the changes with product mix. For example, a weather forecast may be combined with historical purchase data to identify what products are more likely to be purchased in a snowstorm or in the period immediately before or after a snowstorm. Additionally, individual cardholder transaction data may be used to identify specifically which customers are more likely to want to buy different products. For example, if a snowstorm is forecast, the computer system may determine that the merchant is likely to sell a specific number of snow shovels and jackets and that Customers A, B, and C are likely to want both of these products (based on their historical transaction information and any other factors.

The forecasts generated by the merchant computing system and/or by the data provider can also be based on the types of merchant customers. The types of customers can be identified by the merchant or from websites that may query customers for information identifying their demographics and any affiliation with the merchant. For example, an online review website may ask if customers of a restaurant are local repeat customers or transient customers. In other example, the local repeat customer and transient customer information may be extracted from the card information that identifies the number of times particular users have purchased products or services from the merchant and the addresses of the users. Other forecasts may be based on the type of business associated with the merchants, such as a spa vs. a restaurant.

Merchants may also use transaction data 134 to compare their revenue over a given time period to an average or compare revenues with similar type of businesses or other business in a specific geographic area. If revenue performance is below average on a certain day of the week, the computing system may use the transaction data to identify the deficiency and alert the merchant of the issue so actions can be taken to improve revenue performance. For example, the merchant may issue discount coupons for the identified day of the week.

Other examples of analysis that may be performed on transaction data 134 by the computing system may include calculating revenue per square foot or on an occupancy basis. The transaction data 134 and/or social data may be used to determine which customers are visiting different merchants at the same time of the day or on the same days. The transaction data may also be used for evaluating business efficiency based on number of employees or identifying changes in customer spending activity across different geographic locations and merchant categories.

The computing system may also forecast the impact of certain meteorological and external events on revenue, transaction volume, or other business metrics. For example, the computing system may use transaction data and historical weather data to forecast the impact of bad weather on revenue. The computing system may predict the future revenue and predict other business metrics so the merchant is better able to staff their business, adjust hours of operation, inventory, and modify marketing efforts or pricing to minimize the impact of certain negative events or maximize the value of positive events.

The computing system may correlate customer online activity with spending. For example, the computing system may view customer online activity through the use of a cookie or other method. Transaction data from a particular user may be appended with information about other websites the user visits. This information can then be used to help the merchant determine where to allocate or not allocate online marketing dollars in order to capture similar customers. The transaction data may also be used to estimate the lifetime value of customers with a known pattern of online activity in order to appropriately price those potential customers and determine how much money should be spent to acquire them.

The value of social media sites to a given business can be analyzed. Activity may be tracked on a social website page for the merchant and an online social networking service or microblogging service for the merchant. Thousands of other data points about merchant businesses, including revenue may be simultaneously tracked. The computing system may help merchants determine the relative value of specific activities on the different platforms. Merchants could then allocate social media investment to achieve a higher return on investment.

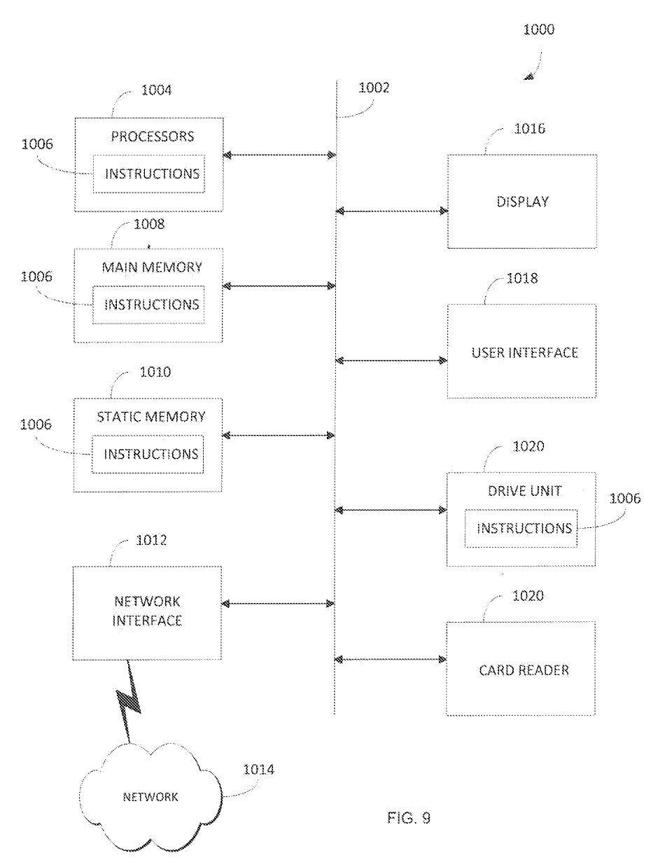

FIG. 9 shows a computing device 1000 executing instructions 1006 for performing any combination of the operations discussed above. The computing device 1000 may operate in the capacity of a server or a client machine in a server-client network environment, or as a peer machine in a peer-to-peer (or distributed) network environment. In other examples, computing device 1000 may be a personal computer (PC), a tablet PC, a Personal Digital Assistant (PDA), a cellular telephone, a web appliance, or any machine capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or portable FLASH key fob. The memory and processing device may be operatively coupled together, or in communication with each other, for example by an I/O port, network connection, etc. such that the processing device may read a file stored on the memory.

Associated memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

For the sake of convenience, operations may be described as various interconnected or coupled functional blocks or diagrams. However, there may be cases where these functional blocks or diagrams may be equivalently aggregated into a single logic device, program or operation with unclear boundaries.

Computing device 1000 can further include a video display 1016, such as a liquid crystal display (LCD) or a cathode ray tube (CRT)) and a user interface 1018, such as a keyboard, mouse, or touch screen. All of the components of computing device 1000 may be connected together via a bus 1002 and/or network.

Having described and illustrated the principles of a preferred embodiment, it should be apparent that the embodiments may be modified in arrangement and detail without departing from such principles. Claim is made to all modifications and variation coming within the spirit and scope of the following claims.

1. A method, comprising:
receiving card information associated with a user;
using the card information for conducting a transaction; and
using, or enabling use, of at least some of the card information for providing transaction data associated with the user.

2. The method of claim 1, wherein:
the card information is used to purchase a product from a merchant; and
the transaction data combines the card information with other card information for other products purchased from other-merchants.

3. The method of claim 1, further comprising:
assigning a user identifier to the card information; and
using the user identifier to identify the transaction data associated with the user.

4. The method of claim 1, further comprising:comparing the transaction data with merchant information for a merchant conducting the transaction with the user.

5. The method of claim 4, wherein the merchant information comprises at least one of a geographic location, a store size, a number of employees, and/or a health inspection score.

6. The method of claim 4, further comprising deriving performance data for the merchant based on the comparison of the transaction data with the merchant information and comparing the performance information for the merchant with performance information for other merchants.

7. The method of claim 1, further comprising comparing the transaction data with website information associated with the user or associated with a merchant conducting the transaction with the user.

8. The method of claim 7, further comprising identifying changes in the website information and forecasting changes in revenue for the merchant based on the changes in the website information.

9. The method of claim 7, wherein the website information comprises online reviews or online ratings for the merchant.

10. The method of claim 7, wherein the website information comprises texts, comments, or ratings directed to the merchant by the user or friends of the user.

11. The method of claim 7, further comprising:
identifying revenue for the merchant from the transaction data;
identifying changes in the website information;
identifying demographic data associated with the user; and
forecasting a change in the revenue based on the changes in the website information and the demographic data associated with the user.

12. The method of claim 1, further comprising enabling use of the card information for producing the transaction data in response to an authorization provided by the user during the transaction.

13. The method of claim 1, wherein using the card information for conducting the transaction comprises sending the card information to a payment gateway for authorization to complete the transaction.

14. The method of claim 13, wherein enabling use of at least some of the card information comprises sending the card information to a data provider.

15. An apparatus, comprising:
a computing system configured to:
receive billing information for purchases by users;
initiate or conduct transactions for completing the purchases;
send, or enable sending, at least some of the billing information for the purchases to a data provider for combining with other billing information for other purchases by the users.

16. The apparatus of claim 15 further comprising a billing database configured to retain the billing information for the purchases by the users.

17. The apparatus of claim 16, wherein the computing system is further configured to store transaction data from the data provider in a transaction database, wherein the transaction data comprises other billing information for the users from other merchants.

18. The apparatus of claim 15, wherein the billing information comprises credit card information or debit card information captured by a merchant computing system.

19. The apparatus of claim 15, wherein the computing system is further configured to enable the data provider to combine the billing information for purchases by the users from different merchants.

20. The apparatus of claim 19, wherein the billing information includes information about products purchased by the users from the different merchants.

21. The apparatus of claim 15, wherein the computing system is further configured to:
compare the billing information with user data, social data, or merchant data; and
determine performance metrics for merchants based on the comparison.

22. The apparatus of claim 15, wherein the computing system is further configured to:
determine a revenue for a merchant based on the billing information;
identifying changes in website data or website activities by the users;
identify demographics for the merchant or the users; and
forecast a change in the revenue based on the changes in the website data or website activities and the demographics for the merchant or the users.

23. The apparatus of claim 15, wherein the computing system is operated by a merchant or payment gateway.

24. The apparatus of claim 23, wherein the computing system and the data provider are operated by different enterprises.

25. An apparatus, comprising:
a computing device configured to:
receive billing information associated with purchases made by users from different merchants;
produce or receive transaction data, wherein the transaction data identifies purchasing information for the users from the different merchants; and
use the transaction data to analyze the purchases made by the users from the different merchants.

26. The apparatus of claim 25 wherein the billing information is used by a payment gateway to authorize payments from the users to the different merchants.

27. The apparatus of claim 26 wherein the billing information comprises credit card or debit card information.

28. The apparatus of claim 25 wherein the computing device is further configured to extract information from websites associated with the users or associated with the different merchants and compare the information with the transaction data.
